(19) United States
(12) Patent Application Publication
(10) Pub. No.: US 2015/0358601 A1
(43) Pub. Date: Dec. 10, 2015

(54) Optical Filter on Objective Lens for 3D Cameras

(71) Applicant: Thierry Oggier, Zurich (CH)

(72) Inventor: Thierry Oggier, Zurich (CH)

(73) Assignee: MESA IMAGING AG, Zurich (CH)

(21) Appl. No.: 12/977,768

(22) Filed: Dec. 23, 2010

Related U.S. Application Data
(60) Provisional application No. 61/289,475, filed on Dec. 23, 2009.

(51) Int. Cl. H04N 13/02; G02B 13/18; G03B 11/00; G02B 5/20; G02B 9/64

(52) U.S. Cl. CPC H04N 13/0203; G02B 9/64; G03B 11/00; G02B 13/18

(57) ABSTRACT

An optical bandpass filter for background light suppression in a three-dimensional time of flight camera is added on one of the lens surfaces inside the objective lens system.

### RELATED APPLICATIONS

This application claims the benefit under 35 USC 119(e) of U.S. Provisional Application No. 61/289,475, filed on Dec. 23, 2009, which is incorporated herein by reference in its entirety.

### BACKGROUND OF THE INVENTION

Three dimensional (3D) time-of-flight (TOF) cameras are active systems that include a light emitter that generates modulated light in a narrow spectral band. As a result, they do not require ambient or background light. In fact, for 3D TOF cameras, ambient light constitutes a noise source that may even cause sensor pixels to saturate.

In order to suppress background light, all 3D time-of-flight cameras on the market use optical bandpass filters such that only light in the narrow spectral band of the light emitter can reach the TOF detector chip.

Background light can originate from artificial light sources (mainly in indoor environment) or from the sun (in outdoor environments). Because of the large amount of background light present in outdoor environments, the need for a spectrally narrow bandpass filter around the emitter's narrow spectral band is especially great in sunlight.

All 3D TOF cameras place an optical filter either in front of the objective lens system or behind the objective.

Examples of cameras with the optical filter placed behind the objective lens have been described in Hagebeuker, “Mehrdimensionale Objekterfassung mittels PMD Sensorik”, Optik & Photonik, March 2008, T. Oggier et al., “An all solid-state optical range camera for 3D real-time imaging with sub-centimeter depth resolution (SwissRanger™)”, Proc. SPIE Vol. 5249, 2004, T. Oggier et al., “SwissRanger SR3000 and first experiences based on miniaturized 3D-TOF Cameras”, 1^{st} range imaging research day, Eidgenössische Technische Hochschule Zürich, 2005, and T. Moeller et al., “Robust 3D Measurement with PMD Sensors”, 1^{st} range imaging research day, Eidgenössische Technische Hochschule Zürich, 2005.

### SUMMARY OF THE INVENTION

The challenge of 3D time-of-flight (TOF) cameras is that a large spectral width of the bandpass filter has to be chosen in order to account for different widths, drifts and tolerances, including the emitter's bandwidth, temperature variation, manufacturing tolerances, and the angle of incidence.

Depending on the field-of-view (FOV) of the cameras, the angle of incidence (AOI) may become the dominant factor in determining the width of the filter's passband.

In general, a higher AOI on the filter shifts the bandpass opening of the filter towards shorter wavelengths.

A bigger AOI requires further increases in the spectral width of the bandpass filter. This allows as much of the light as possible of the active camera system to pass onto the sensor. At the same time, increased levels of background light pass the filter and the resulting image gets increasingly noisy and may reach saturation.

The invention described herein concerns a method and system to reduce the spectral width of the bandpass filter by reducing the effective AOI.

The invention applies the bandpass filter preferably not on a planar surface (usually glass substrate) but instead the filter is directly applied to one of the surfaces inside the objective lens system.

In preferred embodiments, the filter is applied to the posterior surface of one of the lenses with a narrow range of AOIs.

By doing so, the maximum AOI on the filter surface can be minimized and, thereby enabling further spectral narrowing of the bandpass filter.

In general according to one aspect, the invention features a camera comprising an objective lens system, a bandpass filter on a lens in the lens system, and a time of flight detector chip for detecting an image formed by the objective lens system.

In preferred embodiments, the camera is a time-of-flight camera. Further, an angle of incidence (AOI) at the bandpass filter is less than 30 degrees and preferably less than about 10 degrees. Usually, the passband of the bandpass filter is less than 150 nm full-width at half-maximum, and preferably less than 100 nm full-width at half-maximum.

In a current embodiment, there are seven lenses in the objective lens system and the bandpass filter is deposited to the posterior side of said lens.

In general according to another aspect, the invention features a method for configuring a bandpass filter in an objective lens system of a time of flight camera. The method comprises providing an objective lens system for forming an image on a time of flight detector chip and applying the bandpass filter to a lens in the objective lens system.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a plot of typical transmission curves of the optical bandpass filter as used in 3D TOF cameras as a function of the AOI.

FIG. 2 is a cross-sectional view of the objective lens system of a TOF camera including ray traces illustrating an embodiment of the invention.

FIG. 3 is a schematic illustration showing the operation of a TOF camera that includes the inventive objective lens system

### DETAILED DESCRIPTION OF THE PREFERRED EMBODIMENTS

A drawback of state-of-the-art 3D time-of-flight (TOF) cameras is that a large spectral width of the bandpass filter must be chosen in order to account for several different factors, including the AOI. Increased AOIs are correlated with increased bandpass shifts towards shorter wavelengths.

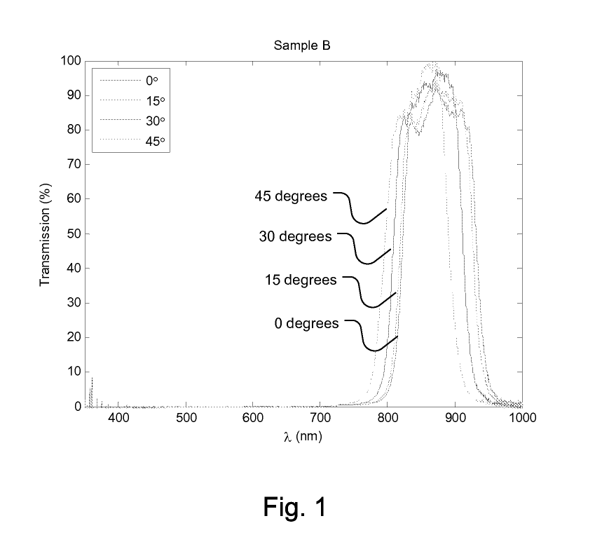

This is illustrated by a plot of typical transmission curves of the optical bandpass filter as used in 3D TOF cameras shown in FIG. 1.

Here, percent transmission is plotted as a function of wavelength. Transmission curves for several different AOIs are shown. As the AOI is increased, a greater shift of the bandpass opening towards shorter wavelengths is observed. Therefore, a larger AOI requires an increase in the spectral width of the bandpass filter, resulting in increased levels of background light passing through the filter and an increasingly noisy image.

By applying the bandpass filter directly to one of the surfaces inside the objective lens system, preferably to the posterior surface of one of the lenses with a narrow range of AOIs, rather than to a planar surface, the maximum AOI on the filter surface can be minimized and, therefore, reduce the effective shift in the filters passband due to AOI.

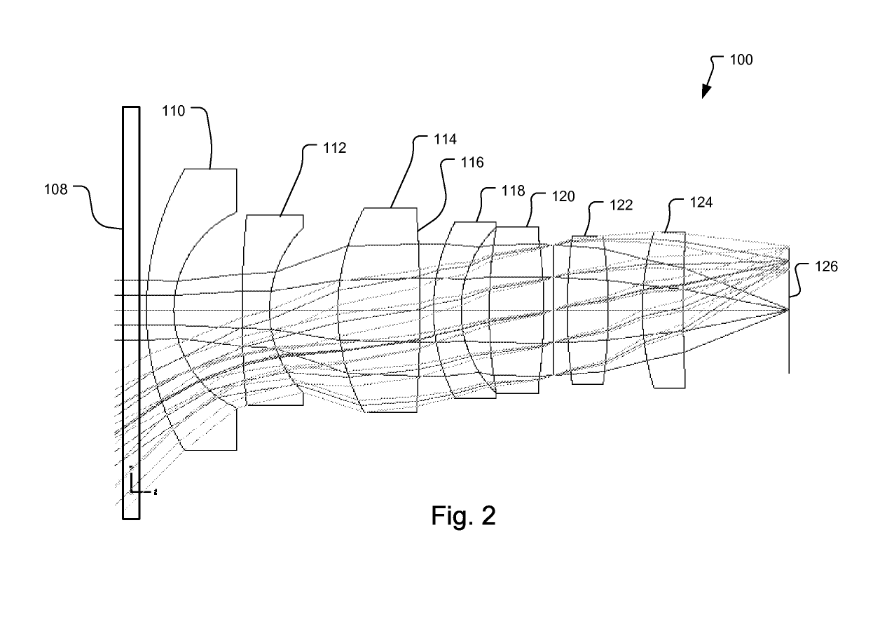

FIG. 2 shows an objective lens system 100 for a 3D TOF camera that has been constructed according to the principles of the present invention.

The objective lens system 100 has seven different lenses treated with anti-reflective (AR) coating. Light is received through a transmissive protective front cover 108 and transmitted sequentially through a first meniscus lens 110, a second meniscus lens 112, a third biconvex lens 114, a fourth meniscus lens 118, a fifth biconvex lens 120, a sixth biconvex lens 122, and a seventh meniscus lens 124. An image is then formed on the TOF detector chip 126.

If a planar optical bandpass filter is added in front of the lens system, i.e., onto front cover 108, the AOI varies between 0 and about 45 degrees. If the bandpass filter is instead added to the inside surface 116 of the third lens 114, replacing the AR coating, the maximal AOI is only 10 degrees.

In the corresponding filter design, an AOI of 45° correspond to a bandpass shift of about 45 nm, whereas the 10° AOI correspond to a shift of only 5 nm. For this reason, the spectral passband window of the bandpass filter can be reduced by about 40 nm. This substantially improves background light rejection enabling operation in sunlight and in other applications with high background light.

In more detail, typically the passband of the filter is about 150 nanometers in bandwidth (full-width at half-maximum, FWHM). By constraining the AOI, the passband is reduced to less than 120 nanometers and preferably less than 100 nanometers FWHM).

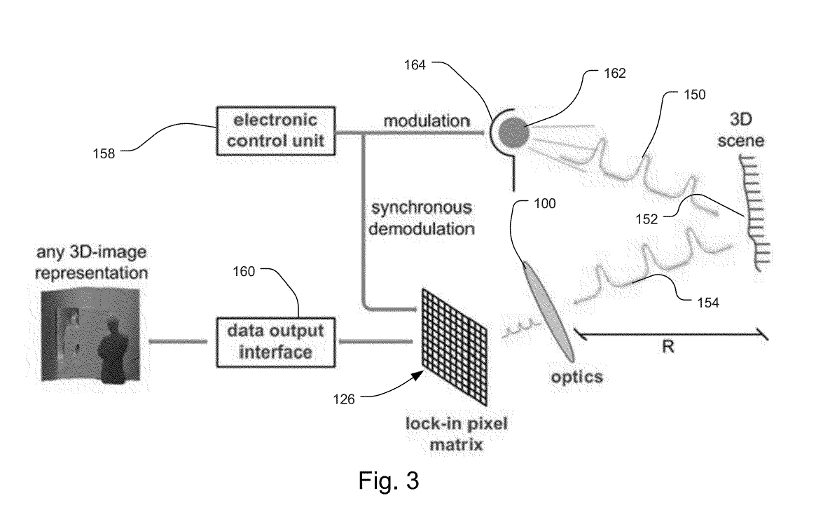

FIG. 3 shows the typical application of a 3D TOF camera.

In more detail, the light emitter 162 with a reflector 164 produces modulated light 150 that is directed at the 3-D scene 152. The returning light 154 from the scene 152 is collected by the objective lens system 100, which includes the bandpass filter so that only light at the wavelength emitted by the light emitter 162 is transmitted. An image is formed on the TOF detector chip 156 which is a two dimensional array of pixels. Control electronics 158 coordinate the modulation of the light emitter 162 with the sampling of the TOF detector chip 156. This results in synchronous demodulation. A data output interface 160 is then able to reconstruct the 3-D image representation using the samples generated by the chip 156 such that a range to the scene is produced for each of the pixels of the chip 156.

While this invention has been particularly shown and described with references to preferred embodiments thereof, it will be understood by those skilled in the art that various changes in form and details may be made therein without departing from the scope of the invention encompassed by the appended claims.

1. A camera comprising:
an objective lens system comprising a plurality of lenses;
a bandpass filter on a non-planar surface of an interior one of the lenses in the lens system, the interior one of the lenses having a range of angles of incidence such that an angle of incidence (AOI) at the bandpass filter is less than 30 degrees; and
a time of flight detector chip for detecting an image formed by the objective lens system.

2. The camera as claimed in claim 1, wherein the camera is a time-of-flight camera.

3. (canceled)

4. The camera as claimed in claim 1, wherein the AOI at the bandpass filter is less than 10 degrees.

5. The camera as claimed in claim 1, wherein a passband of the bandpass filter is less than 120 nm full-width at half-maximum.

6. The camera as claimed in claim 1, wherein a passband of the bandpass filter is less than 100 nm full-width at half-maximum.

7. The camera as claimed in claim 1, wherein there are seven lenses in the objective lens system.

8. The camera as claimed in claim 1, wherein said bandpass filter is deposited to the posterior side of said lens.

9. A method for imaging a scene with a time of flight camera, comprising:
illuminating the scene with modulated light;
collecting light from the scene with an objective lens system for forming an image on a time of flight detector chip of the time of flight camera; and
filtering the light from the scene using a bandpass filter on a non-planar surface of an interior lens in the objective lens system that allows the modulated light to reach the time of flight detector chip, the interior lens having a range of angles of incidence such that an angle of incidence (AOI) at the bandpass filter is less than 30 degrees.

10. The method as claimed in claim 9, wherein all of the lens surfaces without a bandpass filter are coated with an anti-reflective coating.

11. The method claimed in claim 9, wherein the bandpass filter is a posterior side of the lens.

12. A time of flight camera comprising:
a light emitter that produces modulated light directed onto a scene;
an objective lens system for collecting the modulated light returning from the scene, the lens system comprising a plurality of lenses;
a bandpass filter deposited on a non-planar surface of an interior one of the lenses in the lens system, the bandpass filter being transmissive to the modulated light, the interior one of the lenses having a range of angles of incidence such that an angle of incidence (AOI) at the bandpass filter is less than 30 degrees; and
a time of flight detector chip for detecting an image formed by the objective lens system.

13. The camera as claimed in claim 12, wherein the bandpass filter is disposed on a curved surface of the lens.

14. (canceled)

15. The camera as claimed in claim 12, wherein the AOI at the bandpass filter is less than 10 degrees.

16. The camera as claimed in claim 12, wherein a passband of the bandpass filter is less than 120 nm full-width at half-maximum.

17. The camera as claimed in claim 12, wherein a passband of the bandpass filter is less than 100 nm full-width at half-maximum.

18. The camera as claimed in claim 12, wherein said bandpass filter is deposited to the posterior side of said lens.
